(19) United States
(12) Patent Application Publication
(10) Pub. No.: US 2013/0273396 A1
(43) Pub. Date: Oct. 17, 2013

(54) BATTERY BOX

(71) Applicant: Nicholas JACKSON, Carol Stream, IL (US)

(72) Inventor: Nicholas JACKSON, Carol Stream, IL (US)

(73) Assignee: CENTRAL GARDEN & PET COMPANY, Walnut Creek, CA (US)

(21) Appl. No.: 13/447,321

(22) Filed: Apr. 16, 2012

(51) Int. Cl. H01M 2/10; H01M 2/00

(52) U.S. Cl. 429/7

(57) ABSTRACT

A battery box suitable for various applications to support, for example, outdoor lighting requirements. The battery box may utilize one or a plurality of compressive seals to prevent water ingress and makes use of a stacked configuration of components to facilitate assembly and construction.

### FIELD OF THE INVENTION

The present invention is directed at a battery box suitable for various applications to support, for example, outdoor lighting requirements. The battery box utilizes one or a plurality of compressive seals to prevent water ingress which makes use of a stacked configuration of components to facilitate assembly and construction.

### BACKGROUND OF THE INVENTION

Generally, electrical devices rely upon battery support which may be contained within a housing as a power supply. Due to the presence of moist, wet environments there remains an ongoing need to provide simple and effective waterproof performance for the battery storage section.

Battery storage structures for waterproof electric devices are known in the art. Many of these configurations rely upon a loading orifice that is closed by fastening screw members where pressure may then be developed upon a given water-tight seal. In such a configuration, loading forces are not spread relatively evenly on the seal and such configuration may then fail to provide sufficient waterproof performance.

What is needed in the art is a battery storage structure that provide more uniform water-tight sealing that can be readily achieved by the strategic stacking of components along with positioning of elastomeric material that may be compressed to provide waterproof sealing performance.

### SUMMARY

A waterproof battery storage structure comprising an elastomeric keypad, an electronics housing configured to engage with the elastomeric keypad and an elastomeric wire grommet input/output connector for one or a plurality of wires. The storage structure also includes an electronics capture housing and a battery housing, wherein the electronics capture housing is capable of housing a printed circuit board. The elastomeric keypad is capable of compressive sealing engagement with the electronic housing and the electronic housing is capable of compressive sealing engagement with: (a) the wire grommet input/output connector and (b) the electronics capture housing. The electronics capture housing is capable of compressive sealing engagement with: (a) the wire grommet; (b) the electronics housing; and (c) the battery housing.

### BRIEF DESCRIPTION OF THE DRAWINGS

FIG. 1 is a perspective view of the battery storage structure in accordance with an embodiment of the present invention;

FIG. 2 is a stacked view of the electronics housing prior to assembly illustrating how the identified components are assembled.

FIG. 3 is a further perspective view of the electronics housing and battery housing.

FIG. 4 illustrates the preferred indexing feature between the electronics housing and battery housing.

FIG. 5 is a cut-away view of the stacked configuration of components to provide multiple compressive waterproof sealing locations.

### DETAILED DESCRIPTION OF PREFERRED EMBODIMENTS

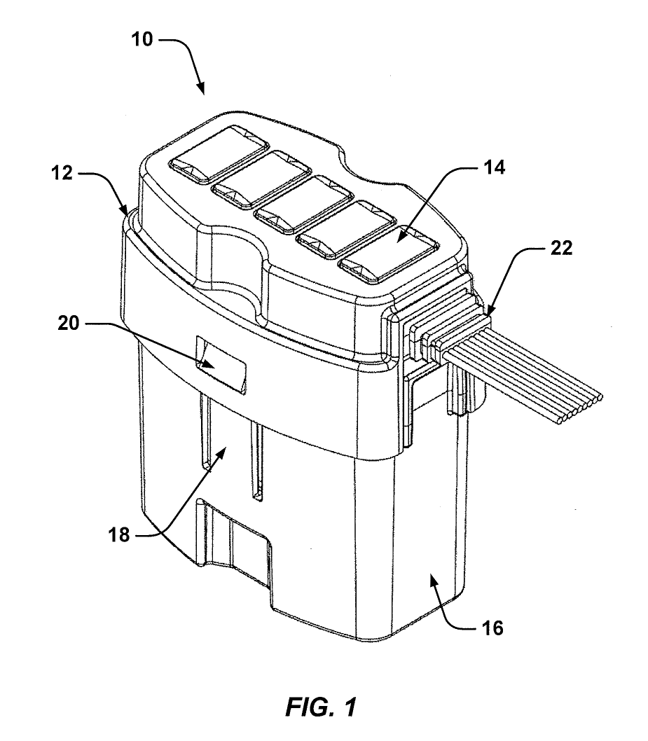

FIG. 1 illustrates a perspective view of the battery storage structure 10 of the present invention. As can be seen, the structure 10 includes an electronics housing 12 that contains a keypad 14. The electronics housing is therefore configured to house components such as the keypad 14 and additional components as discussed herein.

Preferably, the battery housing 16 is mechanically attached to the electronics housing 14, by a clip 18 that engages through an opening 20 on the electronics housing 14. Shown at 22 is a wire grommet input/output connection for one or more wires that may preferably contain a strain-relief type structure and additional sealing capabilities as outlined more fully below.

It should be noted that the electronics housing 14 and the battery housing 16 may be preferably formed of polymeric materials, including various thermoplastic resins such as polyolefins, polystyrene, impact-modified polystyrene, polyesters, polycarbonate, polsulphones, etc. The material selected may preferably be one that is particular resistance to outdoor exposure requirements and interaction with moisture by way of moisture absorption and/or hydrolysis. The battery storage structure 10 including electronics housing 14 and battery housing 16 may be preferably formed by injection molding procedures.

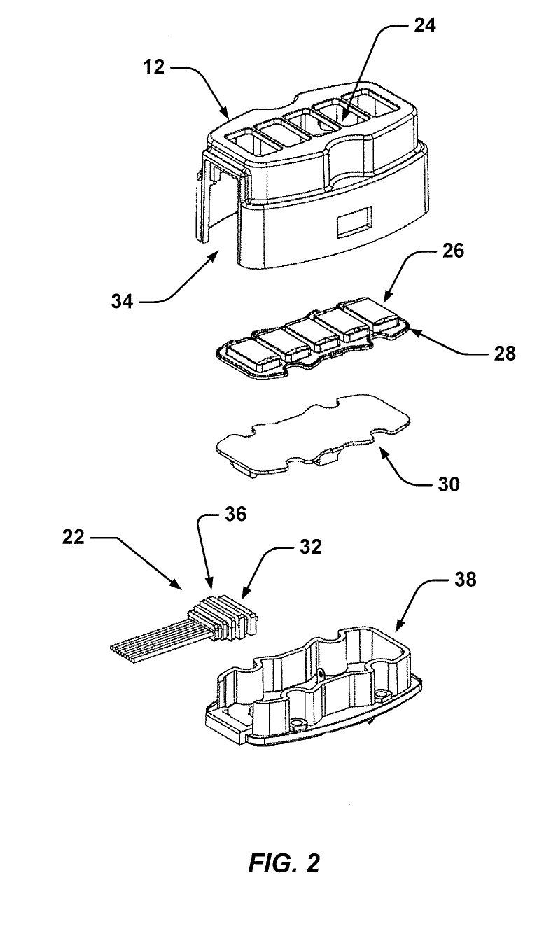

FIG. 2 provides a stacked perspective view of the electronics housing prior to assembly, which therefore best illustrates how the components of the structure 10 are preferably assembled. As can be seen, the electronics housing 12 is preferably configured such that it includes one or a plurality of openings 24 to accommodate keypad 26. Keypad 26 is preferably made of an elastomeric and resilient material such that it may include a peripheral portion 28 that will provide for compressive sealing to the electronics housing 14 to provide a waterproof seal. Accordingly, keypad 26 may preferably be made of elastomeric material which has a Shore Hardness value of between 50-100 A and which elastomeric material also preferably provides good resistance to both polar and non-polar solvents. That is, the elastomeric material will not solubilize in such solvents at room temperature more than 1% by weight and/or undergo swelling at a level of more than 1.0% by volume.

Preferably, the elastomeric material may be sourced from a silicon type elastomer, which may be understood to include polysiloxane type structure, such as polydimethylsiloxane which may be either a thermoplastic or thermoset (crosslinked) resin. Polysiloxanes offer the additional preferred feature that not only will they provide useful compressive properties to form a waterproof seal, the nature of such material is that they will generally provide such useful mechanical characteristics over the temperature range of −50° C. to 200° C., which is more than sufficient for any general outdoor application. Other elastomers are contemplated, such as polyester and/or polyurethane based elastomers, polyamide elastomers, fluropolymer based elastomers, ethylene-propylene rubbers, and styrene-butadiene based elastomers having the Shore A hardness characteristics noted above.

As also illustrated in FIG. 2, a printed circuit board 30 is configured to be positioned underneath the elastomeric keypad 26. This printed circuit board is ultimately in communication with the wires passing through grommet 22 which grommet includes one or a plurality of elastomeric sections 32. The grommet is positioned within opening 34 of electronics housing 12. The elastomeric grommet serves as another convenient sealing feature for the battery storage container 10. The elastomeric grommet as shown is preferably rectangular in shape including a recess portion 36 that provides cooperating surfaces that may therefore be conveniently engaged between protruding edge portions of electronics housing 12 and battery housing 16. FIG. 2 also identifies what may be described as the electronics capture housing 38. The electronics capture housing may be understood as a housing structure that engages with the wire grommet 22 and/or which accommodates the printed circuit board 30. The printed circuit board lies generally beneath the keypad 26 so that pressure inputs from the keypad by the user will lead to output commands from the printed circuit board 30 to an external device.

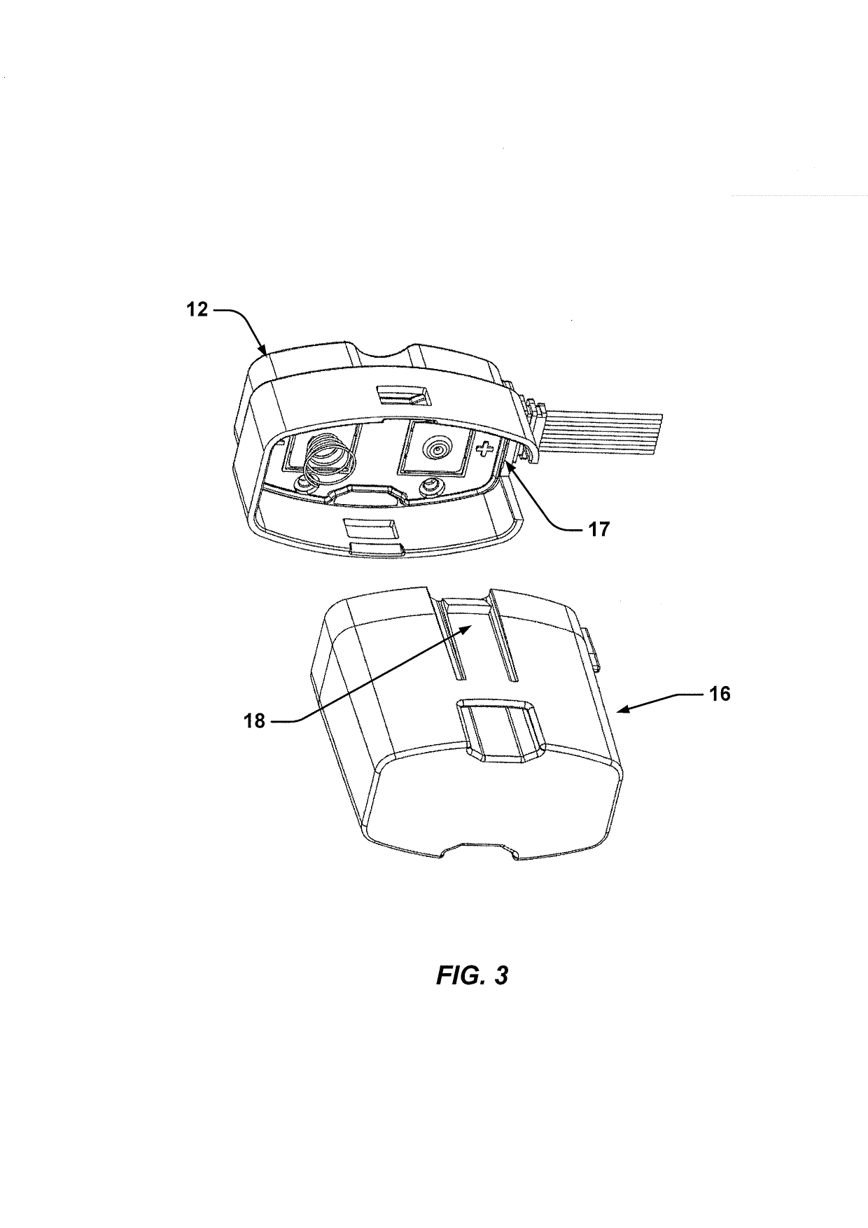

Attention is next directed to FIG. 3 which shows the electronic housing 12 and battery housing 16. As can be seen generally at 17 the bottom or underside of the electronics capture housing 38 includes a peripheral protruding edge portion that may then act to compress an elastomeric seal that may be positioned or overmolded on the bottom or peripheral edge of the electronics capture housing 38 to facilitate sealing. The materials and characteristics of such seal were described above. In addition, as illustrated in FIG. 3, the clip 18 may again be integral and of single-piece construction with the battery housing 16.

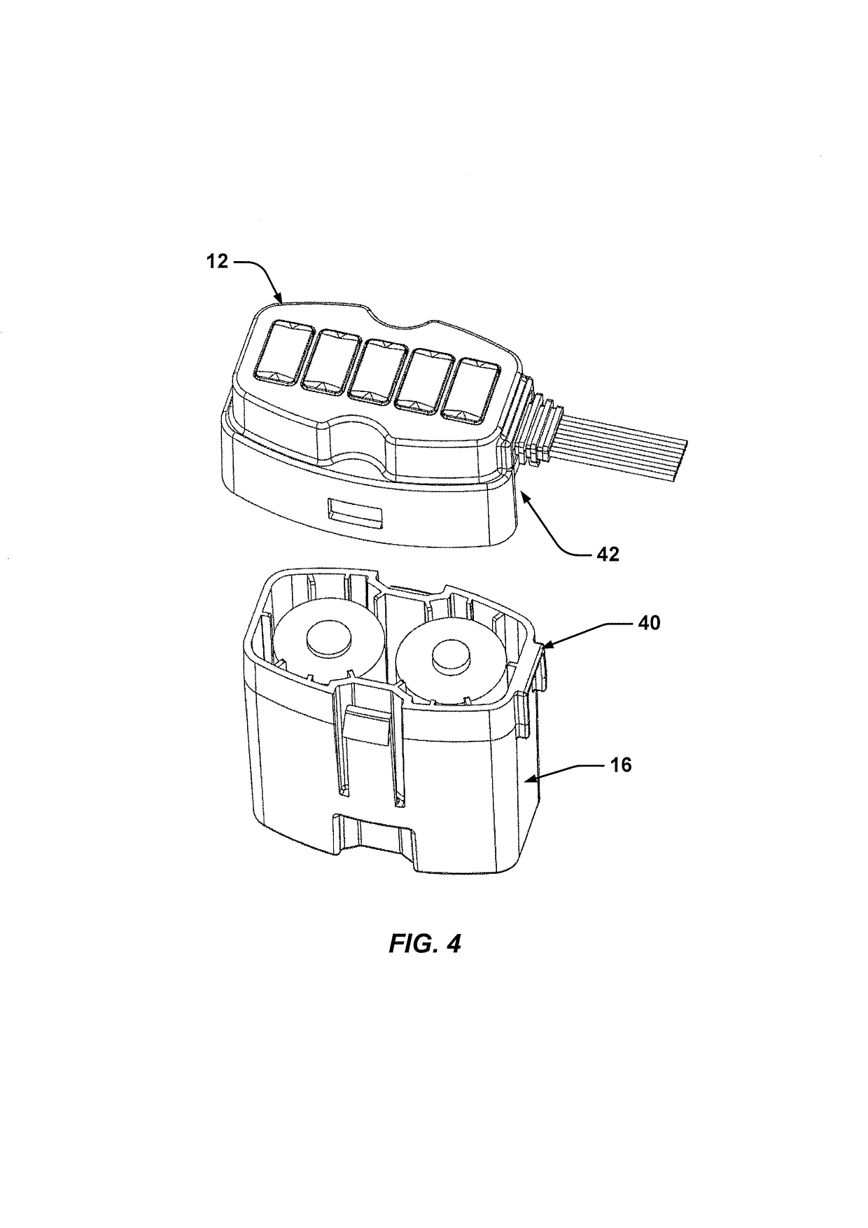

Attention is next directed to FIG. 4 which illustrates the preferred indexing feature of the present invention. That is, the assembly of the battery storage structure herein is such that it will only allow the consumer to assemble in one correct and compressible configuration. More specifically, protruding edge portions 42 necessarily guide battery housing 16 into engagement with electronics housing 12 in only one configuration, as illustrated.

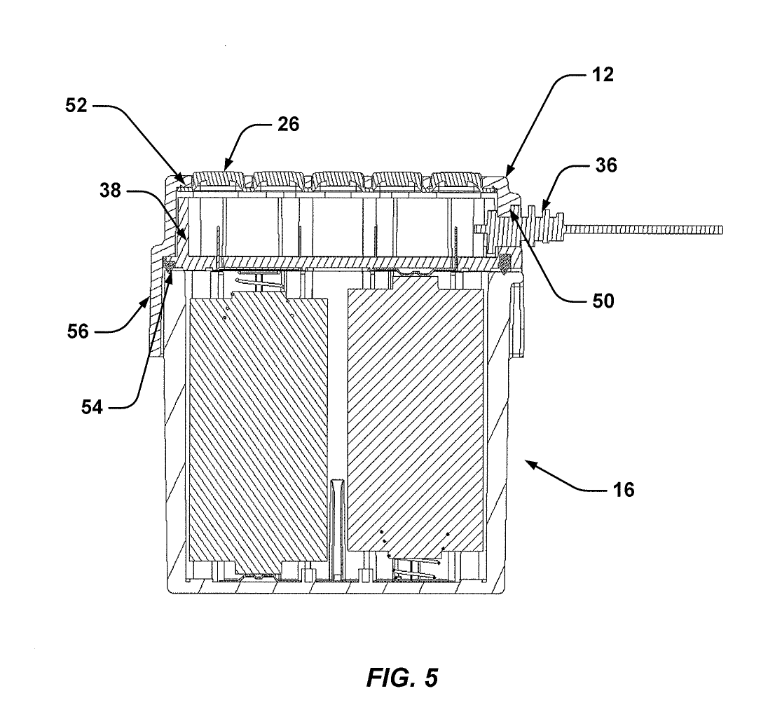

Attention is next directed to FIG. 5 which provides a cut-away view of the stacked configuration of components to provide multiple compressive sealing locations and improved waterproofing and weatherability characteristics. As can be seen, the electronics housing 14 is now engaged in an overall waterproof compressive seal with the battery housing 16. As can be seen at 50 a compressive watertight seal is first located as between the electronic housing 14 and battery housing 16 by way of sealing engagement of an edge portion of the electronics housing 14 within a recess 36 of the elastomeric section of the grommet 22. The elastomeric keypad 26 and it peripheral edge portion 52 also provide compressive sealing and watertight performance as between the keypad 26 and electronics housing 12. The electronics capture housing is shown at 38. A portion of the elastomeric seal as between the electronics capture housing and the battery housing 16 can now be seen at 54.

Preferably, the electronics housing 12 may include an extended portion that may extend down a side of the battery housing 16 to better isolate seal 54 from the environment. For example, the extended portion 56 of the electronics housing 12 may extend down one-third to one-half of the height of the battery housing 16 and overlap the seal as between the electronics capture housing and battery housing. In such manner, electronics housing 12 with extended portion 56 may provide resistance to rain penetration or other moisture when the battery box is used in the outdoor environment.

Accordingly, it may be appreciated that the stacked design herein creates a compressive sealing engagement with overall waterproof performance, without the need for screws or other types of torque-based fasteners between the identified components. This may now be preferably achieved by supplying an electronics housing 12 configured to engage with an elastomeric keypad 14, an elastomeric wire grommet input/output connector 22 for one or a plurality of wires, an electronics capture housing 38 and a battery housing 16. The elastomeric keypad 14 is capable of compressive sealing engagement with the electronic housing 12 and the electronic housing is capable of compressive sealing engagement with: (a) the wire grommet input/output connector 22 and (b) the electronics capture housing 38. The electronics capture housing 38 is capable of compressive sealing engagement with: (a) the wire grommet 22; (b) the electronics housing 12; and (c) the battery housing 16.

The waterproof battery storage structure herein may advantageously be employed to support outdoor lighting requirements where a sealed and waterproof supply of stand-alone electrical power may be required, and where the batteries may now be conveniently replaced without the need for mechanical fasteners such as screws, etc. In particular, the outdoor lighting requirements may include ornamental lighting, although other electrically powered apparatus are contemplated.

Although the invention has been described with respect the certain preferred embodiments, it is to be understood that the present disclosure has been made by way of example only and that changes in the detailed construction may be considered without departing from the spirit and scope of the invention.

What is claimed is:

1. A waterproof battery storage structure comprising:
an elastomeric keypad comprising a plurality of keys and a peripheral portion;
an electronics housing comprising an upper portion comprising a plurality of openings configured to receive said keys and to compressively engage with said peripheral portion of said keypad to form a first water tight seal, said electronics housing further comprising at least one electronics housing sidewall comprising a first opening;
an electronics capture housing having a top side and a bottom side and comprising at least one electronics capture housing sidewall comprising a second opening extending from said top side, said electronics capture housing engaging with said electronics housing to support a circuit board between said top side and said upper portion of said electronics housing and to form a second water tight seal;
an elastomeric wire grommet input/output connector for at least one wire positioned within said first and second openings and comprising cooperating surfaces compressively engaged with edge portions of said first and second openings to form a third water tight seal;
a battery housing comprising a lower portion and at least one battery housing sidewall, said battery housing compressively engaged with said bottom side of said electronics capture housing to form a fourth water tight seal.

2. The waterproof battery storage structure of claim 1 wherein said cooperating surfaces include one or more recess portions and wherein said edge portions of said first and second openings are compressively sealed to at least one of said recess portions.

3. The waterproof battery storage structure of claim 1 wherein said at least one electronics housing sidewall includes an extended portion that extends up to one-half the height of the battery housing and which overlaps the fourth water tight seal.

4. The waterproof battery storage structure of claim 1 wherein said elastomeric keypad comprises an elastomeric material having a Shore A hardness of 50-100 A.

5. The waterproof storage structure of claim 1 wherein said electronics housing and said battery housing are indexed and are capable of joining together in only one configuration.

6. The waterproof storage structure of claim 1 wherein said electronics housing and battery housing are formed of a polymeric material.

7. (canceled)
